(19) United States
(12) Patent Application Publication
(10) Pub. No.: US 2006/0066071 A1
(43) Pub. Date: Mar. 30, 2006

(54) Trailer mounted module

(76) Inventors: Philip Graeme Fisher, Kahibah (AU); Paul Michael Freeman, Mt. Colah (AU)

Correspondence Address: ROBERT PATINO;Law Office of Robert Mark Patino, Suite 505, 1 West Old State Capitol Plaza, Springfield, IL, 62701, US

(21) Appl. No.: 11/100,771

(22) Filed: Apr. 7, 2005

(30) Foreign Application Priority Data
Sep. 27, 2004 (AU) 2004214553

(51) Int. Cl. B60R 3/00

(52) U.S. Cl. 280/165

(57) ABSTRACT

A bathroom module arrangement for a trailer adapted for towing behind a motor vehicle and for positioning substantially on a forward “A” frame part of a chassis of said trailer.

The present invention relates to passenger vehicle trailers, and more particularly to trailers adapted to camping, providing an improved level of accommodation, convenience in use and flexibility of configuration.

### BACKGROUND

Traveling holidays by car and caravan have been a popular activity almost from the inception of the private motor vehicle. Camper trailers have traditionally offered advantages of lower cost and weight for easier towing, but at the price of comfort.

Particularly in more recent times the increased popularity of four wheel drive vehicles and the desire to explore the less accessible parts of a country has led to the need for easily towable yet comfortable trailer-based accommodation with provisions for shower and toilet, not normally available in remote areas. The desire to be able to negotiate rough terrain has placed considerable design constraints on the camper trailer making it difficult to encompass within a small package the desirable features of maneuverability and reasonable accommodation. Frequently, such camper trailers require considerable manipulation to prepare for camping and in many cases cannot readily be used for short roadside stops.

It is an object of the present invention to address or ameliorate at least one of the above disadvantages or to offer a useful alternative.

### BRIEF DESCRIPTION OF INVENTION

Accordingly, in one broad form of the invention, there is provided a camping trailer adapted for towing behind a motor vehicle; said trailer comprising a body divided into:
a. a sleeping portion,
b. a kitchen portion, and
c. a bathroom portion, wherein said bathroom portion is substantially located over a forward “A” shaped towing frame of said trailer.

Preferably, said trailer includes a platform chassis provided at a forward end with said “A” shaped towing frame and towing hitch mechanism adapted for releasable attachment of said trailer to a tow bar of said motor vehicle and provided at a rearmost end with road wheels and suspension elements.

Preferably, said bathroom portion includes side walls, a rear wall and a front wall; said rear wall extending transversely across the width of said chassis platform.

Preferably, said side walls curve forwardly and inwardly from said rear wall; forward edges of said walls terminating at side edges of said front wall; said front wall extending transversely across the width of said “A” shaped frame at a point on said frame where said width is substantially less than the width of said platform.

Preferably, said front wall extends upwardly from said platform to a height sufficiently low so as to allow a user of said bathroom portion to step over said front wall.

Preferably, upper edges of said side walls curve forwardly and downwardly from the junction of said side walls with the top of said rear wall so as to meet forward edges of said side walls at a height approximately half way between the height of said rear wall and said front wall.

Preferably, said bathroom portion is provided with an openable access hatch structure; said openable access hatch hinged from the top edge of said rear wall and shaped so as to provide closure of an opening defined by said upper and said forward edges of said side walls and the upper-edge of said front wall.

Preferably, said side walls and said access hatch are shaped so as to minimize wind resistance of said trailer when under tow.

Preferably, said access hatch and said front wall are adapted to allow entry by a user into said bathroom portion.

Preferably, said access hatch is positioned when opened at a height sufficient to allow an upright posture of a user of said bathroom portion; said access hatch substantially covering floor area of said bathroom portion; said access hatch provided with flexible sheeting forming openable side walls and front wall; said front wall further provided with a zippered access panel.

Preferably, said bathroom portion is provided with shower, hand basin and toilet facilities.

Preferably, said bathroom portion is provided with cupboard space; a portion of said cupboard space accessible from the rear of said rear wall.

Preferably, said kitchen portion is comprised of side walls and a front wall; said front wall extending across the width of said platform and positioned towards the rearmost of said platform.

Preferably, said kitchen portion is provided with a roof extending over said kitchen portion and extending forwardly to the top of said rear wall of said bathroom portion; said kitchen portion further provided with a hinged rear panel hinged from the rear edge of said roof so as to provide closure of said kitchen portion when in a first closed state and an extension of said roof when rotated to a second horizontal state.

Preferably, said kitchen portion is provided with cooking facilities, gas bottles and a refrigerator.

Preferably, said kitchen portion is provided with an array of overhead cupboard spaces having provision for a microwave oven recess; a portion of said cupboard spaces accessible from said kitchen portion and a remaining portion of said cupboard spaces accessible from the front of said front wall of said kitchen portion.

Preferably, said kitchen portion is provided with water storage and retrieval facilities.

Preferably, said kitchen portion is provided with separate storage facilities for one spare wheel.

Preferably, said sleeping portion is provided between said bathroom portion and said kitchen portion; said sleeping portion adapted to accommodate a queen-sized mattress.

Preferably, said sleeping portion is provided with a fold-out bunk bed hinged to said front wall of said kitchen portion.

Preferably, said sleeping portion is provided with hinged side panels; said side panels hinged from side edges of said roof between said bathroom portion rear wall and said kitchen portion front wall so as to provide closure of said sleeping portion when said side panels are in a first closed state, and sidewardly extensions of said roof when said side panels are rotated into a second horizontal state.

In a further broad form of the invention there is provided a method for the construction of a camper trailer adapted for towing by a motor vehicle; said method including the step of providing an integral chassis and platform fitted at a first forward end with a tow hitch mechanism and at a second rear end with road wheels; and wherein a bathroom module is supported on a forward “A” shaped towing frame.

Preferably, said bathroom module is comprised of side walls, a rear wall, a front wall portion and an access hatch; said access hatch being operable while said trailer remains hitched to said motor vehicle; said front wall portion being of a height sufficiently low so as to allow entry into said bathroom module by stepping over said front wall portion.

Preferably, said bathroom module is shaped so as to minimize wind resistance when said trailer is under tow by said motor vehicle.

Preferably, said access hatch provides closure means between said side walls, said rear wall and said front wall portion so as to form an enclosed structure.

Preferably, said access hatch is provided with a hinge attaching to the upper edge of said rear wall; said access hatch providing a roofed area over said enclosed structure when rotated about said hinge to an open position; said access hatch provided with flexible sheeting forming openable side walls and front wall; said front wall further provided with a zippered access panel.

Preferably, said trailer further comprises side walls, a front wall and a roof; said roof extending forward to said rear wall of said enclosed structure; said roof thereby covering a central portion of said trailer disposed between said front wall and said rear wall.

Preferably, said platform is provided at said rear end with a structure adapted to the provision of kitchen facilities; said kitchen facilities including equipment for food preparation, cooking, refrigeration, gas supply, power supply and storage.

Preferably, equipment associated with operation of said trailer includes at least one spare road wheel, at least one power storage battery and charging means; said battery and charging means providing for 240V AC and 12V DC power supply to said trailer.

Preferably, said central portion of said trailer is provided with sleeping facilities.

Preferably, said trailer is provided with panels provided with hinges; a first of said panels hinging from a rearmost edge of said roof and a second and third of said panels hinging from side edges of said roof so as to provide closure means to said structure adapted for provision of kitchen facilities and to said central portion of said trailer and wherein said panels are adapted to provide enclosed annexes to said trailer when rotated into a horizontal position and fitted with detachable flexible sheeting depending from edges of said panels to the ground.

In yet a further broad form of the invention there is provided a bathroom module arrangement for a trailer; said module adapted for positioning substantially on a forward “A” frame part of a chassis of said trailer.

Preferably, said trailer is a caravan; said caravan comprising an enclosed living area defined by a floor, sides walls, a front wall and a rear wall, and a roof.

Preferably, said module is substantially coextensive in a vertical plane at a rearmost end of said module with said front wall of said caravan.

Preferably, side walls of said module curve inwardly and forwardly from said rearmost end to respective outer side edges of a front wall of said module; said front wall located at an intermediate position along said “A” frame between said rearmost end and the apex of said “A” frame.

Preferably, said front wall of said module extends substantially across said “A” frame so as to coincide in width with said “A” frame at said intermediate position.

Preferably, said front wall of said module extends upwardly from said “A” frame to a point intermediate said “A” frame and a plane defined by said roof of said caravan.

Preferably, upper edges of said side walls curve forwardly and downwardly from said roof of said caravan to respective upper corners of said front wall of said module.

Preferably, said module is provided with a curved roof portion extending forwardly and downwardly from a front edge of said roof of said caravan to an upper edge of said front wall of said module; and wherein side edges of said curved roof portion coincide with said upper edges of said side walls when said roof portion is in a first closed position; said side walls, said front wall and said roof portion providing an aerodynamically efficient enclosure.

Preferably, said roof portion is adapted for rotation about a hinge adjoining said front edge of said roof of said caravan, between said first closed position and a second open position.

Preferably, said roof portion assumes an upwardly and rearwardly tilted attitude when in said second open position, so as to provide a greater degree of headroom to a user of said bathroom module than headroom available in said living area.

Preferably, rotation of said roof portion from said first position to said second position is assisted by gas struts.

Preferably, impervious flexible sheeting is provided stretching between said side edges and a front edge of said roof portion, and said upper edges of said side walls and said upper edge of said front wall of said bathroom module, so as provide a weather-proof enclosure when said roof portion is in said second open position.

Preferably, said flexible sheeting stretching between said front edge of said roof portion and said upper edge of said front wall is provided with a section of transparent sheeting to provide access for natural light into said bathroom module when said roof portion is in said second open position.

Preferably, said flexible sheeting is provided with at least one insect proof ventilation aperture.

Preferably, access for a user of said module is provided by an entry door positioned substantially in the centre of said front wall of said living area of said caravan.

Preferably, said module is provided with a centrally located shower base extending substantially between said door and said front wall of said module.

Preferably, said shower base is provided with a waste water drain.

Preferably, said module is provided with a raised platform area at a first side of said shower base; said platform extending between said shower base and a vertical partition; said platform area adapted for support of a chemical toilet unit.

Preferably, a storage space is provided between said vertical partition and a first one of said side walls of said module; said storage space accessible by a hinged door provided in said first one of said side walls.

Preferably, said module is provided with a raised bench top area at a second opposite side of said shower base; said bench top area extending between said shower base and a second one of said side walls; said bench top provided with a hand basin.

Preferably, a storage space is provided beneath said raised bench top area; said storage area accessible by a hinged door provided in said second one of said side walls.

Preferably, said hand basin is provided with at least one water supply outlet and a waste water drain.

Preferably, said module is provided with a shower head adapted for connection to a pump arranged to draw water from a water container.

Preferably, said module is provided with storage recesses arranged one on each side of said entry door; said recesses accessible from said living area of said caravan through respective hinged doors mounted in said front wall of said living area.

In a further broad form of the invention there is provided a bathroom module arrangement according to any one of claims 60 to 83, in combination with a trailer; wherein said bathroom module is positioned substantially over a forward “A” frame section of a chassis of said trailer.

### BRIEF DESCRIPTION OF THE DRAWINGS

Embodiments of the present invention will now be described with reference to the accompanying drawings wherein:

FIG. 1 is a sectioned side elevation of a camper trailer according to the present invention.

FIG. 2 is a plan view of the trailer of FIG. 1 with its roof removed.

FIG. 3 is a front elevation view of the trailer of FIG. 1 when arranged for camping.

FIG. 4 is a rear elevation view of the trailer of FIG. 1 when arranged for camping.

FIG. 5 is a side elevation view of the camper of FIG. 1 when arranged for camping.

FIG. 6 is a side elevation view of a typical caravan to which has been added a bathroom module according to a preferred embodiment of the invention.

FIG. 7 is a plan view of the caravan and bathroom module of FIG. 6 indicating a typical chassis configuration.

FIG. 8 is a side elevation view of caravan configuration according to known prior art.

FIG. 9 is perspective view of the caravan and bathroom module of FIGS. 6 and 7 with the roof portion of the bathroom module in a first closed position.

FIG. 10 is a similar perspective view to that of FIG. 9 with the roof portion of the bathroom module in a second raised position.

FIGS. 11A and 11B are part sectioned side elevation views from each side of a preferred layout of the bathroom module of FIGS. 9 and 10.

FIG. 12 is a plan view of the layout of the bathroom module of FIGS. 9 and 10.

FIG. 13 is a part sectioned elevation view from the front of the bathroom module.

### DETAILED DESCRIPTION OF PREFERRED EMBODIMENTS

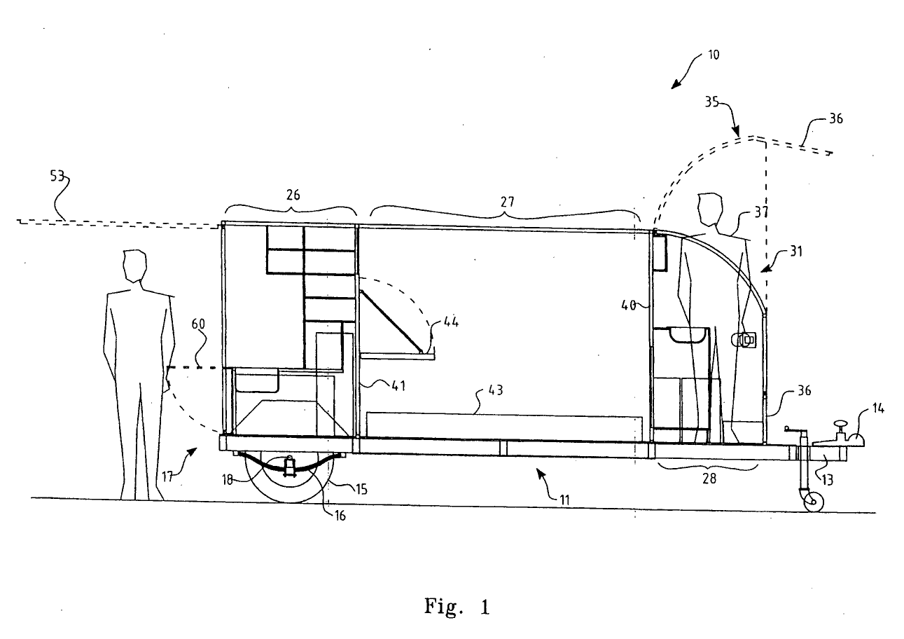

In a broad form of the invention with reference to FIG. 1 there is provided a camper trailer 10 based on an integral chassis platform 11 provided at its forward end 12 with an “A” shaped towing hitch frame 13, hitch mechanism 14 adapted for articulated connection to a towing motor vehicle (not shown), wheels 15 and suspension elements 16 at its rear end 17. In preferred embodiments wheels 15 are placed as far back as practicable so as to leave minimum overhang at the rear of platform 11. This arrangement facilitates the negotiation of rough terrain and significantly reduces the swaying and bouncing of conventional mid-axle trailers when towed at speed over poor road surfaces. As well, due to the greater length between towing hitch 14 and the wheels 15, the manoeuvrability of backing the trailer with a tow vehicle is improved.

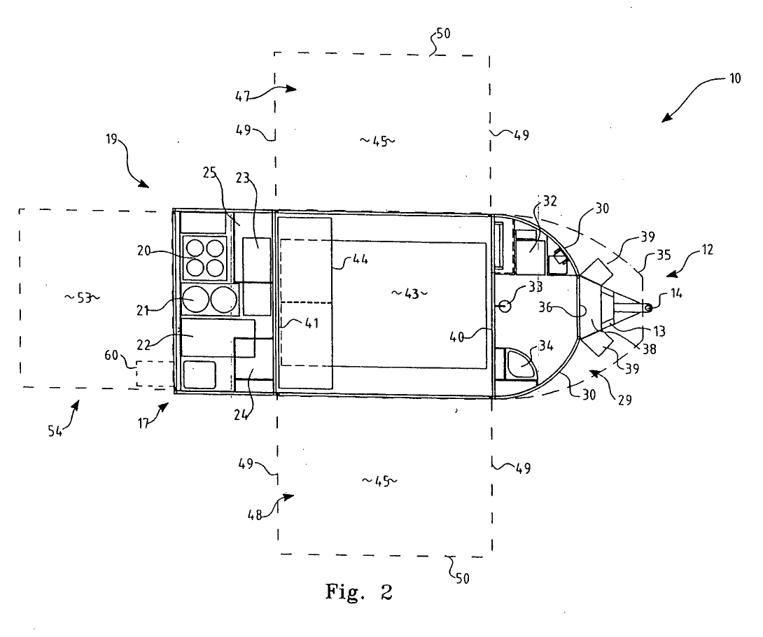

It is a particular object of the present invention that, in so far as is possible, weight distribution is concentrated in the area overlying wheels 15 and transaxle 18, with the overall width, height and length comparable to that of mid-sized car for ease of garaging. Thus as may best be seen in the plan view of FIG. 2, all kitchen area 19 equipment such as cooktop 20, propane gas bottles 21, refrigerator 22, water tank 23, battery storage compartment 24 as well as a spare wheel/s storage 25 are accommodated in this area. Battery and spare wheel storage compartments are accessible from separate kitchen area cupboards of the trailer.

Kitchen area is provided with a benchtop work space fitted with a sink and water tap and a fold-out extension 60 for added bench space. Also arranged in this area as best seen in FIGS. 1 and 4 is a system of overhead storage cupboards 26 some of which are accessible from the kitchen area 19 and some from the middle portion 27 of the trailer. The placement of the bulk of the weight over the rearward mounted wheels further ads to the stability of the trailer under tow.

With reference to FIGS. 1 and 2, in preferred embodiments the forward portion 28 of trailer 10 is provided with a bathroom area 29 having fixed side walls 30 and an openable upper portion 31. Bathroom area 29 is rounded both in plan section as shown in FIG. 2 and at its openable upper portion 31 as shown in side elevation view of FIG. 1 so as to minimize wind resistance when towing. This forward portion of trailer 10 is fitted with chemical toilet 32, shower 33 and handbasin 34 facilities. Additionally, forward portion 28 is provided with cupboard space disposed along rear wall 40 with a portion of this cupboard space being accessible from within middle portion 27.

Openable portion 31 is in the form of a hinged access hatch 35 forming the roof and part of the front wall 36 of bathroom area 29 and extending downwardly along the front of the bathroom area sufficient to allow access by a user 37 by stepping over a low fixed front wall 36.

Access hatch 35 is adapted to swing forwardly and upwardly into the position shown dashed in FIG. 1. In this position hatch 35 provides a roof over forward portion 28 at a height allowing a user 37 of the facilities to stand under it. Hatch 35 preferably is urged into its open position by suitable gas struts (not shown) and is further be provided with attached canvas or other flexible sheeting so arranged as to depend from hatch 35 to provide privacy to a user. This sheeting is provided with a zippered door in the front. Towing hitch frame 13 is provided with a small platform area 38 and fold-down steps 39 so as to allow easy entry into bathroom area 29.

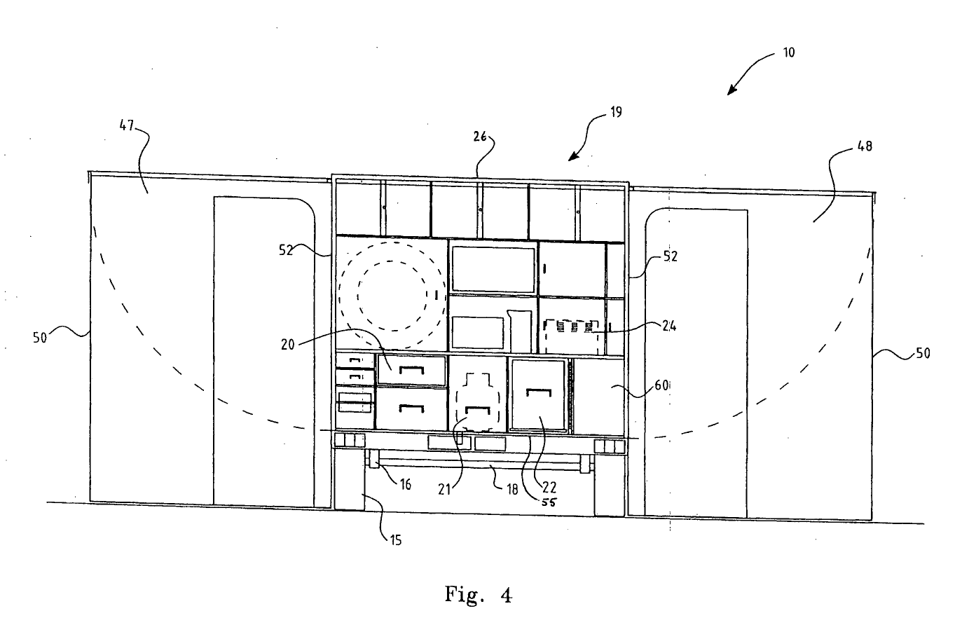

It will be appreciated that this arrangement allows the toilet facility to be used without any setting up of the trailer for camping and while still attached to the towing vehicle 56 if required, as shown in FIG. 5.

The middle portion 27 of trailer 10 is closed off from both forward portion 28 and kitchen area 19 by internal walls 40 and 41 respectively, and provides a permanent sleeping area. Middle portion 27 is further provided with fixed flexible sheeting with zippered access panels and flyscreen sections at both sides. Its roof 42 is fixed, forming a continuous structural element from internal wall 40 and extending to cover kitchen area 19. Middle portion 27 is sufficiently large to accommodate a standard queen-sized mattress 43 (or two single mattresses) with optional fold-out bunk-bed 44 suitable for a child. Access to middle portion 27 is from either side of trailer 10 by means of swing-up panels 45.

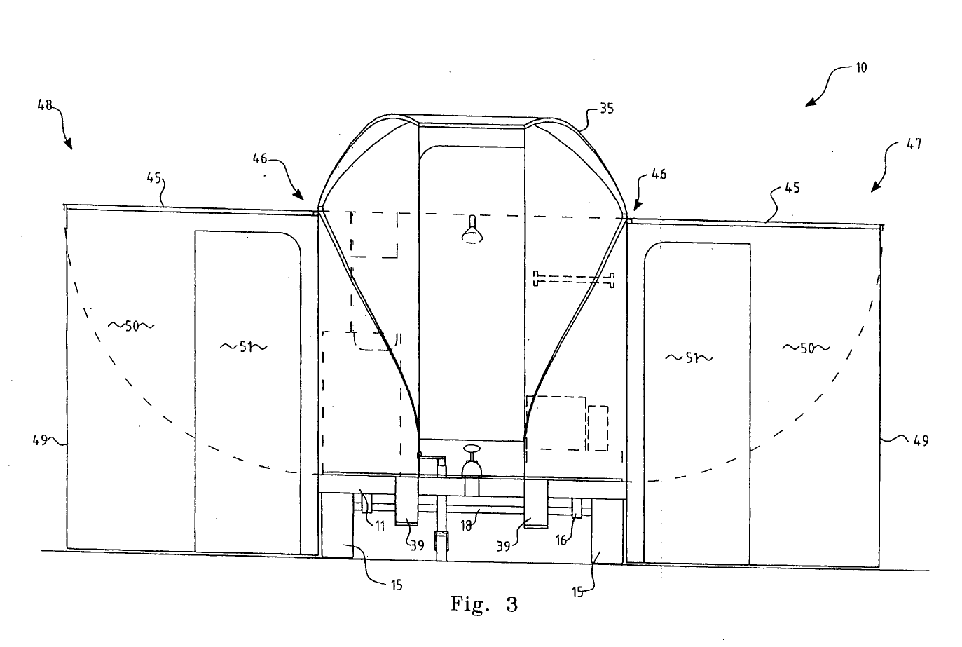

Panels 45 are hinged from roof edges 46 and, when urged into fully opened positions as shown in FIG. 3, provide roofed accommodation annexes 47 and 48. Panels 45 may be assisted into their opened positions by for example gas struts (not shown) and are provided with attachable canvas or otherwise flexible sheeting so as to form enclosing side walls 49 during inclement weather, and end walls 50 around accommodation annexes 47 and 48. Entry doors 51 in the form of zippered or otherwise secured flaps are provided in suitable positions in side or end walls to give access to the accommodation annexes 47 and 48.

With reference to FIG. 4, kitchen area 19 is constructed with fixed side walls 52 joining roof 42. Access to the kitchen area 19 and other equipment at the rear of trailer 10 is provided by hinged panel 53 as shown in FIG. 1. When in its opened position as shown by dashed lines in FIG. 1, panel 53 provides a covered work area 54 at the rear of the trailer. Being placed at the rear of trailer 10 and accessible by the opening of panel 53 the kitchen area 19 is readily available for use even during short roadside stops. Optionally, when set up for camping, flexible sheeting side and end walls may be attached to panel 53 as shown in FIG. 5 so as to form an enclosed kitchen area.

Kitchen area 19 is provided with drawer slide arrangements 55 for access to refrigerator 22. Propane gas bottles 21 are accommodated in an enclosed drawer, vented underneath, which may be slid rearwardly for access to the bottles. Spare wheel/s are accessible via an access door provided in the rear of the kitchen area.

All panels 45 and 53 and hatch 35 when in the closed position are lockable and, with all equipment contained within the body of the trailer, there is a reduced likelihood of theft or damage.

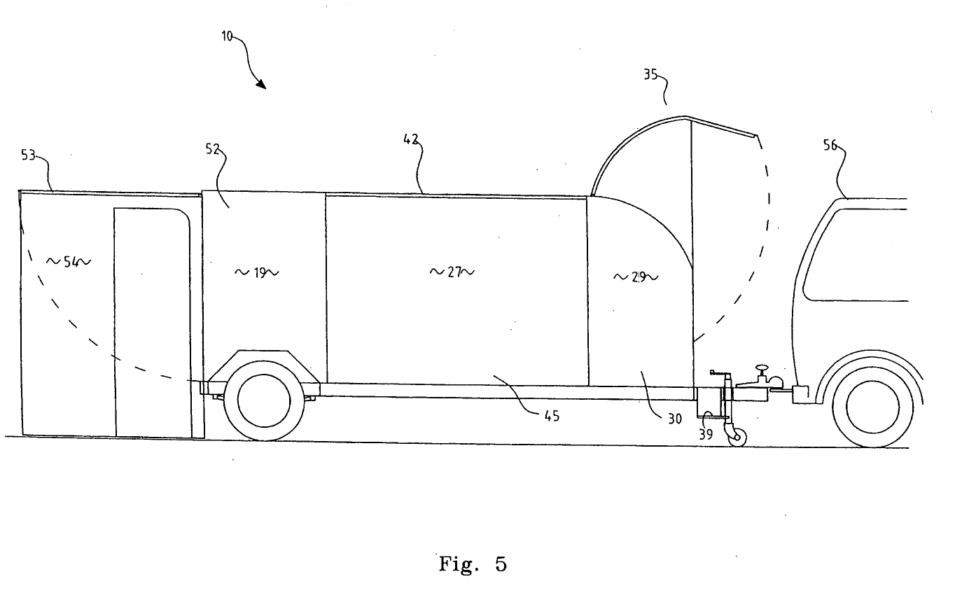

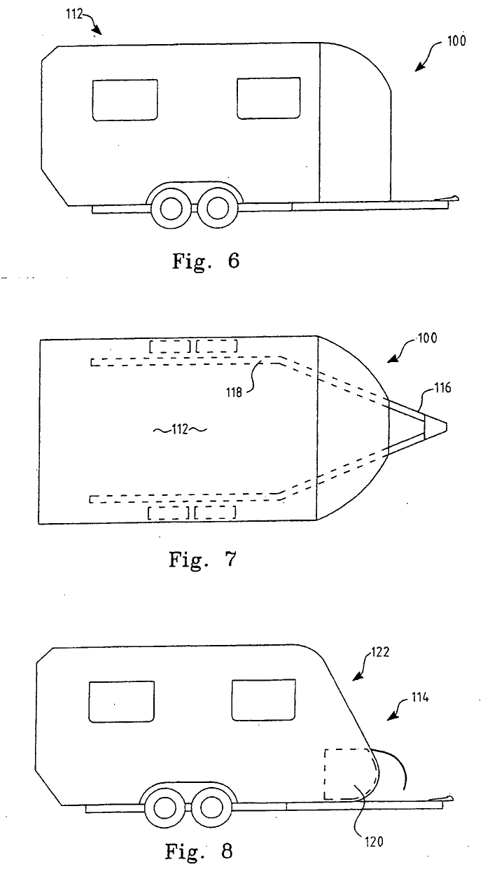

In a further preferred embodiment of the present invention with reference to FIGS. 6 and 7 a bathroom module arrangement 100 is adapted as a suitable addition to a caravan 112. In particular, the bathroom module arrangement 100 may be incorporated as an extension of existing caravan designs without any, or at least any substantial increase in overall length.

A typical caravan design is shown in FIG. 8 where a forward portion 114 of the caravan 112 may extend partially over the “A” shaped towing frame 116, which is usually an integral extension of the caravan chassis 118, leaving the greater part of the towing frame 116 largely unused. If the caravan includes a bathroom, it is usually located at the rear end of the caravan and adds significantly to its overall length. In many designs the front of the caravan is formed as a more or less vertical wall with little concession to aerodynamic efficiency. Alternatively, in some designs. as illustrated in FIG. 8, the forward portion 114 may incorporate one or more storage compartments 120 and is then typically provided with a rearwardly sloping, forward facing wall 122 to somewhat reduce the wind resistance of the caravan when under tow.

The living area of a caravan 112 then extends rearwardly from the forward portion 114. It may typically include a pair of single beds on either side of a central passage leading to a wardrobe at the front wall of the caravan as for example.

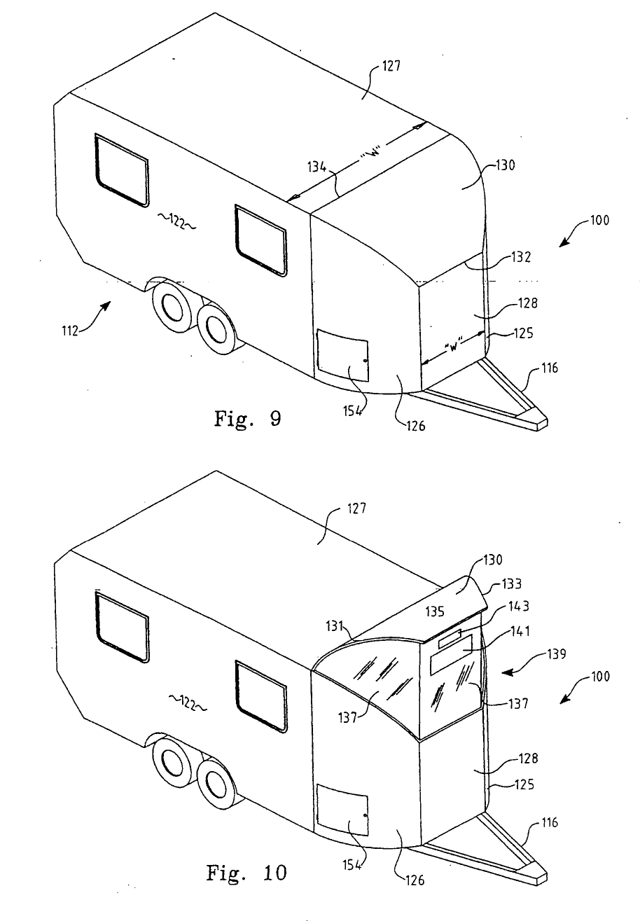

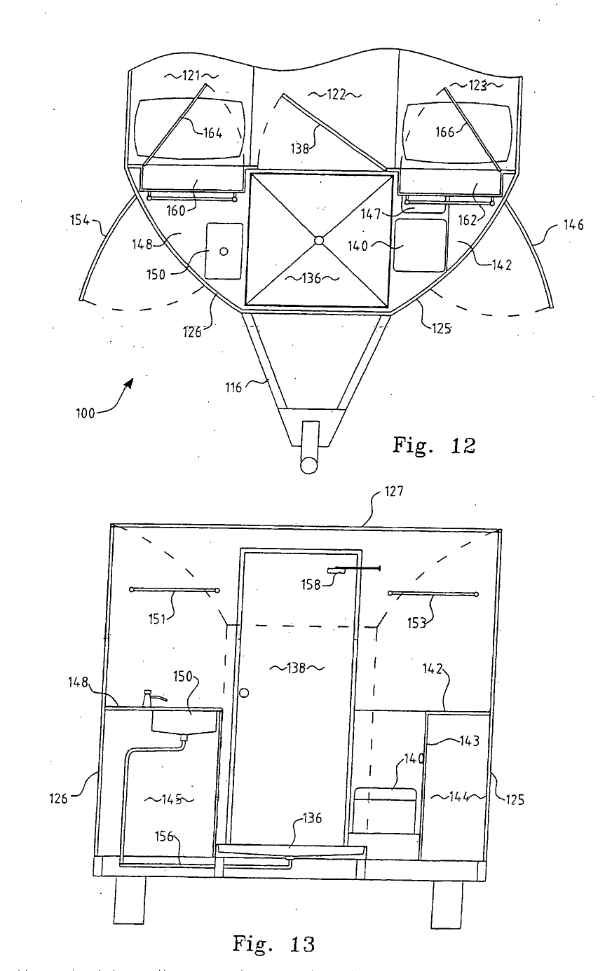

With reference now to FIGS. 9 to 13, the bathroom module 100 according to a preferred embodiment of the present invention, is designed to form an extension to the living area 122 of an existing caravan design and is disposed entirely over the “A” shaped towing frame 116. The arrangement of the module 100 is such as to allow entry from the interior of the caravan in which it is incorporated. In the layout of the living area described above for example, the wardrobe between the beds 121 and 123 (in FIG. 12) may be removed to allow a passageway leading to a door in the front wall of the van opening onto the bathroom module. Such an arrangement may be seen in FIG. 12 for example. The foregone storage space of the wardrobe is at least partly offset by a feature of the module as described hereunder.

In a preferred form as shown in FIG. 9, the bathroom module is formed as an aerodynamically efficient shell with inwardly curving side walls 125 and 126 extending from the full width of the caravan “W” to a narrower front wall 128 width “w” extending across the “A” shaped towing frame 116. Front wall 128 extends vertically from the towing frame 116 to a point intermediate between the level of the towing frame 116 and the roof 127 of the caravan 112. Module 100 is further provided with a curved roof portion 130 extending forwardly and downwardly to meet the upper edge 132 of front wall 128.

In at least one preferred form of the bathroom module, curved roof portion 130 of the module 100 may be rotated from its normally closed position as shown in FIG. 9, to an open position about a hinge 134 adjacent to the front roof edge of the caravan 112 as shown in FIG. 10, so that when the bathroom is to be used, particularly for showering, the raised roof portion 130 provides additional head room over a shower base 136 located in the middle of the module (as shown in FIG. 12).

When unlatched for use, roof portion 130 may be driven into an open position by gas struts (not shown) for example. Roof portion 130 has attached at its two side edges 131 and 133 and along its front edge 135, weather proof, flexible and opaque material 137, in turn attached at its lower edges to the upper edges of side walls 125 and 126 and front wall 128, so as to form a weather proof enclosed space 139 rising from the module when the roof portion 130 is raised. Preferably, at least the front portion of this flexible material 137 is provided with a transparent panel 141 and a fly-wire covered vent 143 to provide light and ventilation when the roof is in its raised position.

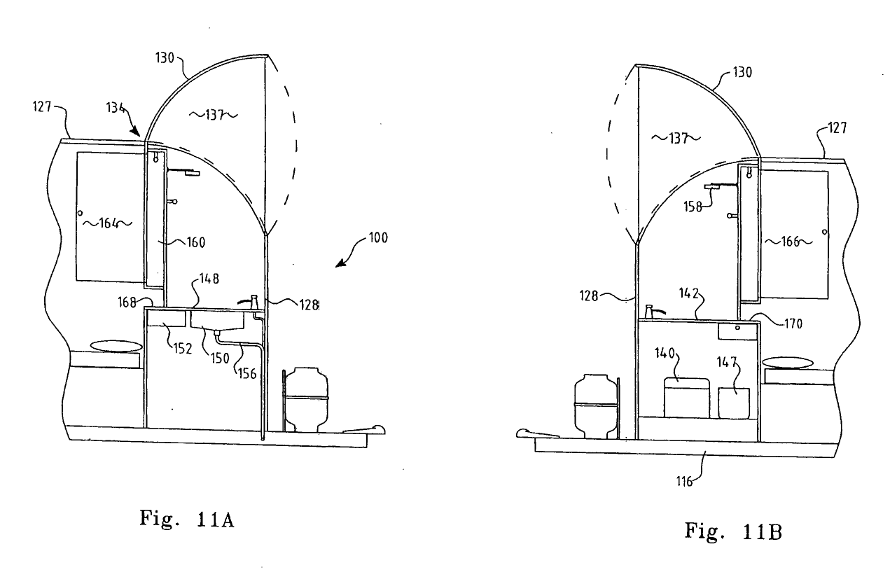

A preferred layout of the module is shown in the elevation views of FIGS. 11A and 11B and on the plan view of FIG. 12. An access door 138 opens out from the central area of the module and a shower base 136. To one side of the shower base 136 (the right hand side in the illustrated example), is a space for a chemical toilet unit 140. A raised bench top 142 and partition 143 may be provided behind the toilet unit 140 thereby forming a storage space 144 between partition 143 and side wall 125 and under bench top 142.

This storage space 144 may be accessed from outside the module via a door 146 in side wall 125. In addition, space beside toilet unit 140 may accommodate a container as a hot water source for the shower, for example.

The space on the opposite side of the shower base 136, may be provided with a raised bench top 148 containing a hand basin 150 and space for toiletries and the like. The hand basin 150 may be provided with water outlets for both onboard and mains water supplies. At least a portion of the space below the bench 148 may be used for one or more drawers 152 and the remaining space may be made accessible from outside via a door 154 in side wall 126 to provide further storage space 145.

Both the hand basin 150 and the shower base 136 are provided with drainage plumbing 156 connecting either to a kitchen area sink drain (if provided) or to a separate drainage point (not shown) mounted to the outside of the bathroom module. The shower may be provided by an extendable shower head 158 mounted for example to one side of the door 138 and supplied with water via a pump (not shown). The pump can for example draw a supply of warm water prepared in the kitchen area and placed in a suitable receptacle 147 beside the toilet unit 140.

On either side of the door 138 giving entry into the bathroom area, cupboard spaces 160 and 162 may be recessed into the module 100 with doors 164 and 166 opening out into the living area 122 of the caravan 112 so as to provide hanging space for clothing. By arranging these cupboard spaces so as to stop short some little way above the level of the bench tops 142 and 148, convenient shelf spaces 168 and 170 are created for use in the living area 122. The walls on either side of the door opening may be provided with towel racks 151 and 153, as shown in FIG. 13 for example.

The bathroom module thus provides a lightweight space efficient addition to many standard caravan designs without adding to the overall length of the caravan or imposing on it available living area.

The above describes only some embodiments of the present invention and modifications, obvious to those skilled in the art, can be made thereto without departing from the scope and spirit of the invention.

1. A bathroom module arrangement for a trailer; said module adapted for positioning substantially on a forward “A” frame part of a chassis of said trailer.

2. The module of claim 1 wherein said trailer is a caravan; said caravan comprising an enclosed living area defined by a floor, sides walls, a front wall and a rear wall, and a roof.

3. The module of claim 2 wherein said module is substantially coextensive in a vertical plane at a rearmost end of said module with said front wall of said caravan.

4. The module of claim 3 wherein side walls of said module curve inwardly and forwardly from said rearmost end to respective outer side edges of a front wall of said module; said front wall located at an intermediate position along said “A” frame between said rearmost end and the apex of said “A” frame.

5. The module of claim 4 wherein said front wall of said module extends substantially across said “A” frame so as to coincide in width with said “A” frame at said intermediate position.

6. The module of claim 4 wherein said front wall of said module extends upwardly from said “A” frame to a point intermediate said “A” frame and a plane defined by said roof of said caravan.

7. The module of claim 4 wherein upper edges of said side walls curve forwardly and downwardly from said roof of said caravan to respective upper corners of said front wall of said module.

8. The module of claim 7 wherein said module is provided with a curved roof portion extending forwardly and downwardly from a front edge of said roof of said caravan to an upper edge of said front wall of said module; and wherein side edges of said curved roof portion coincide with said upper edges of said side walls when said roof portion is in a first closed position; said side walls, said front wall and said roof portion providing an aerodynamically efficient enclosure.

9. The module of claim 8 wherein said roof portion is adapted for rotation about a hinge adjoining said front edge of said roof of said caravan, between said first closed position and a second open position.

10. The module of claim 8 wherein said roof portion assumes an upwardly and rearwardly tilted attitude when in said second open position, so as to provide a greater degree of headroom to a user of said bathroom module than headroom available in said living area.

11. The module of claim 9 wherein rotation of said roof portion from said first position to said second position is assisted by gas struts.

12. The module of claim 8 wherein impervious flexible sheeting is provided stretching between said side edges and a front edge of said roof portion, and said upper edges of said side walls and said upper edge of said front wall of said bathroom module, so as provide a weather-proof enclosure when said roof portion is in said second open position.

13. The module of claim 12 wherein said flexible sheeting stretching between said front edge of said roof portion and said upper edge of said front wall is provided with a section of transparent sheeting to provide access for natural light into said bathroom module when said roof portion is in said second open position.

14. The module of claim 12 wherein said flexible sheeting is provided with at least one insect proof ventilation aperture.

15. The module of claim 2 wherein access for a user of said module is provided by an entry door positioned substantially in the centre of said front wall of said living area of said caravan.

16. The module of claim 15 wherein said module is provided with a centrally located shower base extending substantially between said door and said front wall of said module.

17. The module of claim 16 wherein said shower base is provided with a waste water drain.

18. The module of claim 16 wherein said module is provided with a raised platform area at a first side of said shower base; said platform extending between said shower base and a vertical partition; said platform area adapted for support of a chemical toilet unit.

19. The module of claim 18 wherein a storage space is provided between said vertical partition and a first one of said side walls of said module; said storage space accessible by a hinged door provided in said first one of said side walls.

20. The module of claim 16 wherein said module is provided with a raised bench top area at a second opposite side of said shower base; said bench top area extending between said shower base and a second one of said side walls; said bench top provided with a hand basin.

21. The module of claim 20 wherein a storage space is provided beneath said raised bench top area; said storage area accessible by a hinged door provided in said second one of said side walls.

22. The module of claim 20 wherein said hand basin is provided with at least one water supply outlet and a waste water drain.

23. The module of claim 1 wherein said module is provided with a shower head adapted for connection to a pump arranged to draw water from a water container.

24. The module of claim 15 wherein said module is provided with storage recesses arranged one on each side of said entry door; said recesses accessible from said living area of said caravan through respective hinged doors mounted in said front wall of said living area.

25. The module of claim 1, in combination with a trailer; wherein said bathroom module is positioned substantially over a forward “A” frame section of a chassis of said trailer.
